(19) United States
(12) Patent Application Publication
(10) Pub. No.: US 2006/0150070 A1
(43) Pub. Date: Jul. 6, 2006

(54) Mobile communication method and system

(76) Inventors: Panu Korhonen, Helsinki (FI); Mika Roykkee, Pirkkala (FI); Juha Kaario, Tampere (FI); Ramalingam Hariharan, Tampere (FI); Veera Lattunen, Helsinki (FI); Aki P. Happonen, Kiiminki (FI)

Correspondence Address: PERMAN & GREEN, 425 POST ROAD, FAIRFIELD, CT, 06824, US

(21) Appl. No.: 11/027,101

(22) Filed: Dec. 30, 2004

(51) Int. Cl. G06F 17/00

(52) U.S. Cl. 715/500.1; 715/501.1

(57) ABSTRACT

An advertising method and system for a mobile communication system that includes at least one mobile communication terminal, a controller and a presentation device. Main presentation content is obtained in the mobile communication terminal. The main presentation content is associated with the promotional content. The main presentation content is provided to the presentation device. The promotional content is provided to the presentation device for presentation in such a manner that the promotional content is presented in connection with the main presentation content.

### BACKGROUND OF THE INVENTION

1. Field of the Invention

The present invention relates generally to the field of mobile communications and particularly to advertising by way of presentation of promotional content.

2. Brief Description of Related Developments

Communication devices have during the last decades evolved from being more or less primitive telephones, capable of conveying only narrow band analog signals such as voice conversations, into the multimedia mobile devices of today capable of processing large amounts of data representing any kind of data, including text data, as well as very complex multi media content and game data.

Many mobile communication terminals now include a camera capable of recording both still images and video sequences. These images and sequences are often shared between terminal users, i.e. the users capture images and video sequences and send these to other users. This sharing of images is sometimes performed over large distances via mobile communication systems, but also very often performed over short distances, terminal to terminal, using short-range wireless connection techniques such as Bluetooth, WLAN, UWB etc.

Characteristic of this way of sharing content is that the visibility of the operator of the mobile communication system to which the sending terminal is connected tends to decrease. That is, when sending/sharing images and video sequences, users tend to disregard the fact that they are using a communication device that is an integrated part of a complex and expensive to run mobile communication system that is operated, and, often owned, by a specific network operator.

### SUMMARY OF THE INVENTION

An object of the present invention is hence to solve a problem of how to increase the visibility of a mobile communication system operator to users.

This object is achieved by providing an advertising method, a communication system configured for advertising using a mobile communication terminal and a computer program, according to different aspects of the invention, as defined in the appended claims.

In a first aspect of the present invention a method of presenting advertising and promotional materials is used in a mobile communication system. The communication system comprises at least one mobile communication terminal, a controller and a presentation device. As part of the method, a number of steps are performed, namely, obtaining main presentation content, associating the main presentation content with promotional content, and providing the main presentation content. The above steps may be performed at the mobile communications terminal. The controller performs the step of providing the promotional content for presentation in connection with the main presentation content.

In another aspect of the present invention, the presentation of the main presentation content is accomplished with the associated promotional content. Alternatively, the presentation of the main presentation content with the promotional content is provided through a link to the promotional content that allows the viewer to obtain the promotional content for presentation. That is, when a user displays or shares main presentation content such as an image or a video sequence that has been captured with the mobile communication terminal, an association is made with promotional content that is to be displayed together with the presentation content. Preferably, a predefined link to the promotional content is associated with the presentation content. This link may refer directly to an operator's promotional content server, to a device manufacturer's content server or to any other content server, containing advertising, i.e. promotional, content. The promotional content referred to by the link is fetched either by the mobile communications terminal or by the presentation device, when the presentation device is able to connect to the promotional content server through, for example, the Internet.

In another aspect of the present invention, the presentation of the promotional content in connection with the main presentation content involves simultaneous presentation of the promotional content and the main presentation content. Alternatively, the presentation of the promotional content in connection with the main presentation content involves sequential presentation of the promotional content and the main presentation content.

For example, when displaying the main presentation content in the form of an image, promotional content in the form of a logotype may be displayed on top of the image. Another example is a user establishing a connection to a home television to show main presentation content in form of a video captured with the mobile communication terminal. When the connection is ready, an operator advertisement video starts to run on the TV, after which the main presentation content is shown.

In another aspect of the invention, a mobile communication system is configured for advertising, where the system comprises: a mobile communication terminal that allows the capture of material that comprises the main presentation content for transmittal; a promotional content server configured to provide promotional content; a controller configured to associate the main presentation content with the promotional content; and a presentation device configured to receive and present the promotional content in connection with the main presentation content.

In one aspect of the present invention, the controller is an integrated part of the mobile communication terminal.

In a further aspect of the present invention the presentation device is connected to the mobile communication terminal via a short-range wireless connection such as Bluetooth, W-LAN, UWB etc.

In another aspect of the present invention, the presentation device is connected to the mobile communication terminal via a computer network connected to the mobile communication system. Such a computer network may be an Internet Protocol (IP) network. Alternatively, the presentation device is a second mobile communication terminal in a second mobile communication system connected to the mobile communication system.

In another aspect of the present invention, the promotional content server is connected to the controller via a computer network. In another aspect of the invention, the promotional content server is connected to the controller via the mobile communication system.

In another aspect of the present invention, a mobile communication terminal includes controlling means, communication means and memory means configured to perform any of methods described above.

In another aspect of the present invention, a computer program is provided comprising software instructions that, when executed in a mobile communication terminal, performs any of the methods described above.

The present invention advantageously increases the visibility for the operator in proximity environments. Another advantage is that the operator may receive extra revenue by selling the advertising opportunity to a third party.

An additional advantage is that the user experience is harmonized as the visibility of the operator expands into proximity communication.

### BRIEF DESCRIPTION OF THE DRAWINGS

FIG. 1 schematically illustrates a functional block diagram of a mobile communication terminal according to an embodiment of the present invention.

FIG. 2 schematically illustrates interconnected systems and components used directly or indirectly in the invention.

FIG. 3 is a flowchart of a method according to the present invention.

FIG. 4 is a block diagram of one embodiment of an apparatus that can be used to practice features of the present invention.

### DETAILED DESCRIPTION OF THE PREFERRED EMBODIMENT(s)

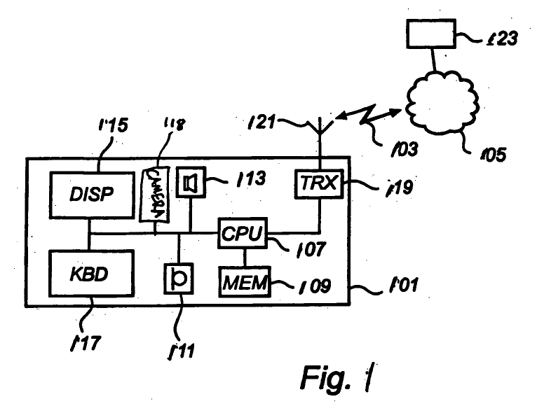

FIG. 1 illustrates schematically a communication terminal 101 in which the present invention is implemented. The terminal 101 is capable of communication via an air interface 103 with a radio communication network 105 such as the well known systems CDMA2000, D-AMPS, GSM, UMTS, EDGE, etc. The terminal comprises a processor 107, memory 109 as well as input/output units in the form of a microphone 111, a speaker 113, a display. 115, a keyboard 117 and a camera 118. Radio communication is realized by radio circuitry 119 and an antenna 121. Connected to the radio communication network 105 is a controller 123. The details regarding how these units communicate are known to the person skilled in the art and is therefore not discussed further.

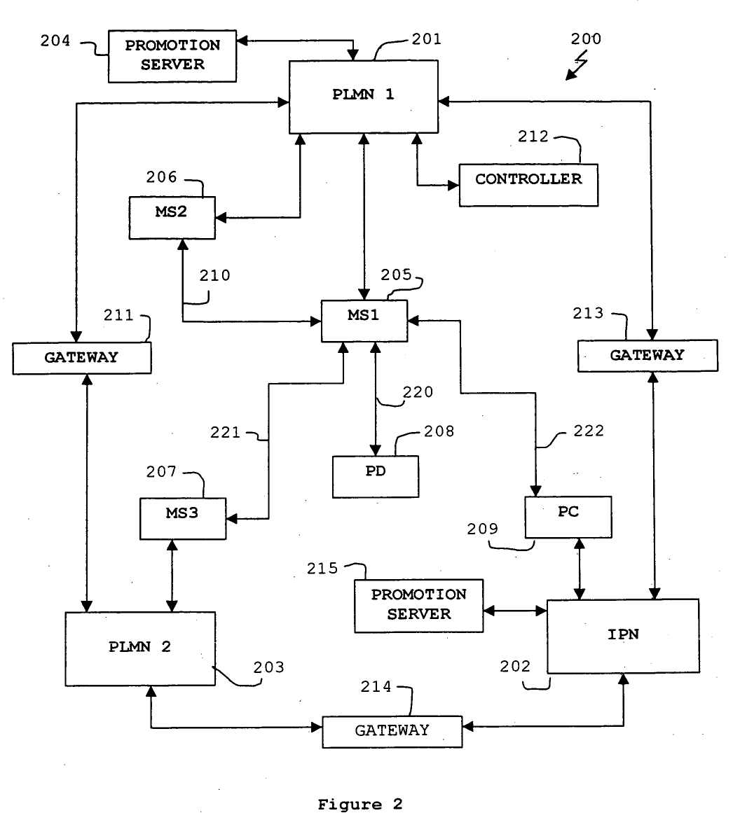

FIG. 2 shows a diagram of interconnected systems and components 200 used directly or indirectly in the invention. Naturally, many more components exist in the described systems, but these have deliberately been left out as they are known in the art and would only obscure the description of the present invention. There are three networks shown: a first public land mobile network (PLMN) 201, an Internet Protocol network (IPN) 202 and a second public land mobile network (PLMN) 203.

The first PLMN 201 may be of any type including, but not restricted to, CDMA2000, D-AMPS, GSM, UMTS, EDGE, etc. Connected to the first PLMN 201 is a promotional content server 204. The server stores promotional content in the form of, e.g. advertising images and video sequences, and is configured to deliver this when requested by a first mobile communications terminal 205 or a presentation device (206, 207, 208 or 209).

The first terminal 205 is connected to the first PLMN 201 through a wireless connection in accordance with the mobile network technology used in the first PLMN 201, the details of which are known in the art. The terminal 205 is of the general type illustrated in FIG. 1. Terminal 205 is configured for obtaining main presentation content, such as pictures and video sequences by using a camera, such as the camera 118 in FIG. 1. The terminal 205 is also capable of associating promotional content, from sources such as server 204, with the main presentation content. In an alternate embodiment the promotional content can be obtained by a third party promotional content provider having a server accessible to the mobile terminal 205. Depending on the substance of the promotional content, it may be stored in memory within the mobile communications terminal 205 or, in the alternative, in an auxiliary memory directly connected to the terminal 205

Alternatively, controller 212, is also connected to the first PLMN 201 to provide the function of associating main presentation content with promotional content. As an alternative embodiment the functions of controller 212 could be provided by processor 107 of a mobile communications terminal.

As shown in FIG. 2, mobile terminal 205 is capable of communicating with a variety of destinations through PLMN 201 and other means. Through these connections mobile terminal 205 is configured to send materials, described herein as main presentation content to any of the indicated destinations, for viewing on the terminal devices at the destination.

Second mobile communication terminal 206 is connected to the first PLMN 201. The second terminal 206 is capable of acting as a presentation device by way of being configured to present both main presentation content and promotional content. The first terminal 205 and the second terminal 206 are configured such that the first terminal 205 can transfer content to the second terminal 206, either via the first PLMN 201 or via a proximity connection 210. The proximity connection 210 may be realized in many different ways, either wireless, such as Bluetooth, W-LAN, UWB, etc. or wired-based, such as serial cable, USB, IP, etc. The details of these transfer mechanisms are known to a man skilled in the art and as such will not be discussed further here. A stand alone presentation device (PD) 208, such as a television, car audio, navigation system, mobile music device, home theatre, home music system, etc. is also capable of being connected to the first terminal 205 through a proximity connection 220 like proximity connection 210 is described above.

As known in the art, gateways 211, 213, 214 are configured to interconnect the public land mobile networks 201 and 202 with each other and with other networks.

The Internet Protocol network (IPN) 202 may be a local area network or a global network, such as the Internet, or any other IP-based network.

A promotional server 215 is connected to the IP network 202, serving the same purpose as the promotional server 204 described above. Also connected to the IP-network is a computer 209, such as a personal computer, a hand held computer, etc. The computer is connected to the first terminal 205 through a proximity connection 222 like proximity connection 210 is described above. As known in the art, the IP-network is connected to other networks through appropriately configured gateways 213, 214.

The second PLMN 203 may be of any type including, but not restricted to, CDMA2000, D-AMPS, GSM, UMTS, EDGE, etc. Specifically the second PLMN 203 does not need to be of the same type as the first PLMN 201. Connected to the second PLMN 203 is a third mobile communication terminal 207. The third terminal 207 is configured such that the first terminal 205 is able to transfer content (main and promotional) either through a proximity connection 221 like proximity connection 210 is described above or through the interconnected first PLMN 201, gateway 211 and second PLMN 203.

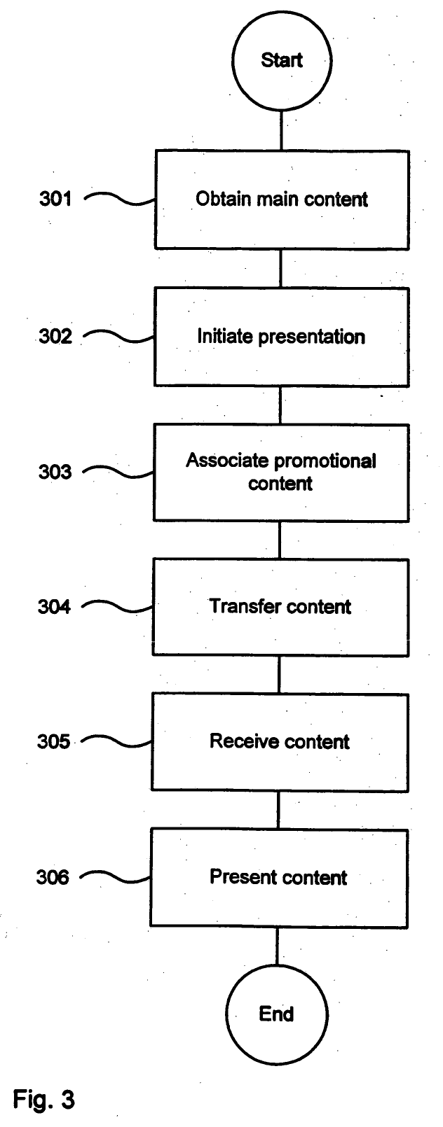

A method according to the invention will now be described with reference to the flow chart in FIG. 3. A mobile communication terminal is utilized in this method and could be the first mobile communication terminal 205 in FIG. 2. A presentation device such as one of the presentation devices 206, 207, 208, or 209 in FIG. 2 is also used in this method, as well as a promotional content server such as one of the promotional content servers 204 or 215 in FIG. 2.

In an obtain main presentation content step 301, the terminal 205 obtains main presentation content when triggered by a user. For example, content is obtained by capturing a digital image or a video sequence, by receiving content from another terminal, such as 206 or server, such as available through Internet network 202, or by using any other resource within the communication capability of the mobile terminal 205, such alternative sources for main presentation content is within the scope of the present invention.

In an initiate presentation step 302, the terminal accepts input, such as a keypad input or menu selection, etc. from the user indicating that the main presentation content is to be transferred to a presentation device.

In an associate promotional content step 303, the terminal controller or other controller, such as network controller 212, associates promotional content with the main presentation content in one of two scenarios. In a first scenario, the terminal fetches the promotional content from a promotional content server, to be transferred to the presentation device in a later step. In a second scenario, the terminal only associates a link, such as a URL to the promotional content with the main presentation content, so that the presentation device in a later stage may fetch the promotional content referred to by the link.

In a transfer content step 304, the terminal transfers the main presentation content to the presentation device. The transfer is performed over a proximity connection. The proximity connection may be realized in many different ways, either wireless, such as Bluetooth, W-LAN, UWB, etc. or wired-based, such as serial cable, USB, IP, etc.

In the first scenario as described in the associate promotional content step 303 above, the terminal also transfers the promotional content. In this scenario, the promotional and main presentation content may be bundled into one package or alternatively, the two content types may be transferred separately. In the second scenario as described in the associate promotional content step 303 above, the terminal transfers the main presentation content and the link to the promotional content.

In a receive content step 305, the presentation device receives the content transmitted in step 304, including any promotional content or link to promotional content. The receiving step includes interpreting the content, i.e. separating main presentation content and any links or promotional material included in the transfer. If promotional and main presentation content are transferred separately, no logic is required in the presentation device to distinguish between the two content types and the presentation device simply presents the current content transferred to it in a present content step 306 described below, regardless if the content is main presentation content or promotional content.

In a present content step 306, the transferred content is presented to a viewer using the presentation device. If associated promotional material exists, the presentation device will present both the main presentation content and the promotional content. If the promotional content is referred to with a link and the presentation device has the ability, the presentation device will either fetch the promotional material from the promotional content server or stream the content from the server for presentation. The presentation can either be performed in sequence, where at any time only the promotional content or the main presentation content is presented, or simultaneously, e.g. by superimposing a logotype (promotional content) on the main presentation content. A person skilled in the art will easily realize other ways to simultaneously present both the main and the promotional content.

If promotional material can not be determined from the transfer, the presentation device simply presents the content as is known in the art, with no regard to if the content is main presentation content or promotional content.

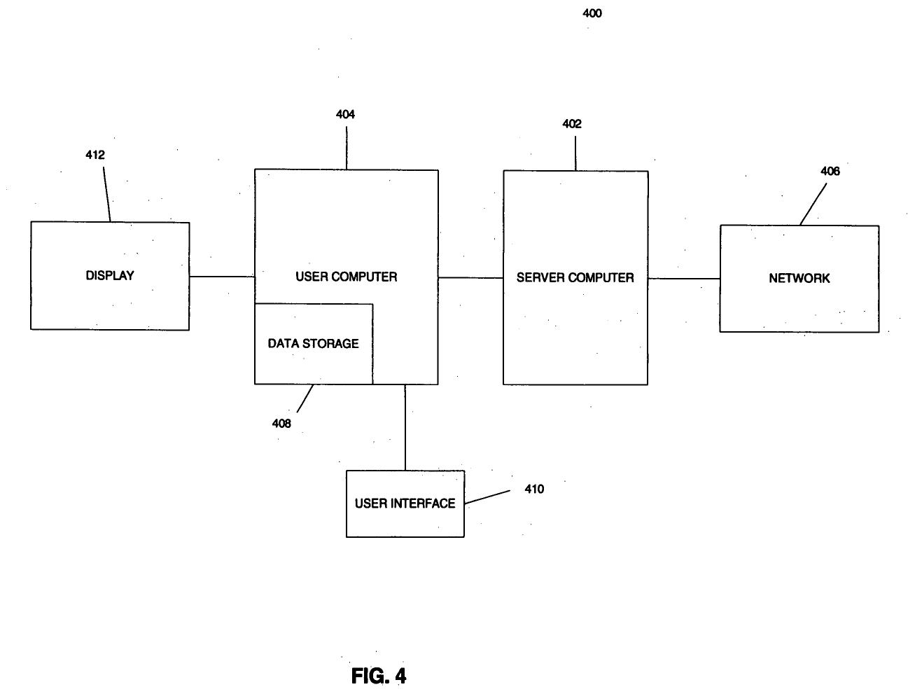

The present invention may also include software and computer programs incorporating the process steps and instructions described above that are executed in different computers. In the preferred embodiment, the computers are connected to the Internet. FIG. 4 is a block diagram of one embodiment of a typical apparatus 400 incorporating features of the present invention that may be used to practice the present invention. As shown, a computer system 402 may be linked to another computer system 404, such that the computers 402 and 404 are capable of sending information to each other and receiving information from each other. In one embodiment, computer system 402 could include a server computer adapted to communicate with a network 406, such as for example, the Internet. Computer systems 402 and 404 can be linked together in any conventional manner including a modem, hard wire connection, or fiber optic link. Generally, information can be made available to both computer systems 402 and 404 using a communication protocol typically sent over a communication channel or through a dial-up connection on ISDN line. Computers 402 and 404 are generally adapted to utilize program storage devices embodying machine readable program source code which is adapted to cause the computers 402 and 404 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 402 and 404 may also include a microprocessor for executing stored programs. Computer 402 may include a data storage device 408 on its program storage device for the storage of information and data. The computer program or software incorporating the processes and method steps incorporating features of the present invention may be stored in one or more computers 402 and 404 on an otherwise conventional program storage device. In one embodiment, computers 402 and 404 may include a user interface 410, and a display interface 412 from which features of the present invention can be accessed. The user interface 408 and the display interface 410 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. An advertising method in a mobile communication system: comprising at least one mobile communication terminal, a controller and a presentation device, comprising the steps of:
obtaining main presentation content in the mobile communication terminal;
associating the main presentation content with promotional content;
providing the main presentation content to the presentation device; and
providing the promotional content to the presentation device for presentation in such a manner that the promotional content is presented in connection with the main presentation content.

2. The method, according to claim 1, wherein the step of association is executed in the mobile communications terminal.

3. The method, according to claim 1, wherein the step of association is executed in a network controller.

4. The method according to claim 1, wherein the association of the main presentation content with the promotional content comprises obtaining the promotional content.

5. The method according to claim 1, wherein the association of the main presentation content with the promotional content comprises obtaining a link to the promotional content and wherein the provision of the main presentation content and the promotional content for presentation to a viewer comprises presentation of promotional content linked to by the link.

6. The method according to claim 1, wherein the presentation of the promotional content in connection with the main presentation content involves simultaneous presentation of the promotional content and the main presentation content.

7. The method according to claim 1, wherein the presentation of the promotional content in connection with the main presentation content involves sequential presentation of the promotional content and the main presentation content.

8. The method according to claim 1, wherein the promotional content is provided by a promotional content provider.

9. The method, according to claim 1, wherein the promotional content is obtained from a promotional content server accessible through the mobile communications network.

10. The method, according to claim 1, wherein the promotional content is contained in a memory of the mobile communications terminal.

11. A mobile communication system configured for advertising, comprising:
a mobile communication terminal, the terminal being configured to obtain a main presentation content,
a promotional content server configured to provide a promotional content,
a controller configured to associate the main presentation content with the promotional content, and
a presentation device configured to receive and present the promotional content in connection with the main presentation content.

12. The system according to claim 11 where the mobile communication terminal and the controller are configured in such a manner that the controller is an integrated part of the mobile communication terminal.

13. The system according to claim 11 where the presentation device is connected to the mobile communication terminal via a short-range wireless connection.

14. The system according to claim 11 where the presentation device is connected to the mobile communication terminal via a computer network connected to the mobile communication system.

15. The system according to claim 11 where the presentation device is a second mobile communication terminal in the mobile communication system.

16. The system according to claim 11 where the presentation device is a second mobile communication terminal in a second mobile communication system connected to the mobile communication system.

17. The system according to claim 11 where the promotional content server is connected to the controller via a Internet Protocol based computer network.

18. The system according to claim 11 where the promotional content server is connected to the controller via the mobile communication system.

19. The system according to claim 11, wherein the promotional content server comprises a memory integral with or auxiliary to the mobile communication terminal.

20. A computer program product comprising:
a computer useable medium having computer readable code means embodied therein for causing a computer to advertise in a mobile communication system including at least one mobile communication terminal, the computer readable code means in the computer program product comprising:
computer readable program code means for causing a computer to obtain main presentation content in the mobile communication terminal;
computer readable program code means for causing a computer to associate the main presentation content with promotional content;
computer readable program code means for causing a computer to provide the main presentation content to a presentation device; and
computer readable program code means for causing a computer to provide the promotional content to the presentation device for presentation in such a manner that the promotional content is presented in connection with the main presentation content.
